(19) United States
(12) Patent Application Publication
(10) Pub. No.: US 2009/0260505 A1
(43) Pub. Date: Oct. 22, 2009

(54) METHOD FOR THE EFFICIENT IMPLEMTIONATION OF A WAVETABLE OSCILLATOR

(75) Inventors: Ytai Ben-Tsvi, Tel Aviv (IL); Seeon Birger, Ramat-Gan (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/104,051

(22) Filed: Apr. 16, 2008

(51) Int. Cl. G10H 7/00

(52) U.S. Cl. 84/604

(57) ABSTRACT

A method for organizing a wave sample in a memory comprises loading the wave in two parts, each of which is a continuous waveform, wherein a discontinuity is provided between said two parts.

### FIELD OF THE INVENTION

The present invention relates to the field of digital audio synthesis. More particularly, the invention relates to an efficient method for operating a wavetable oscillator.

### BACKGROUND OF THE INVENTION

The DLS (downloadable sound) standard (as well as most other wavetable standards) defines a strict audio synthesis model, based on manipulation of wave samples stored in the synthesizer's memory. One of the components performing these manipulations is called “wavetable oscillator”. The oscillator basically has two functions: it performs pitch shift and looping. Pitch shift is an operation in which the wave is played back at a different rate than it was originally recorded, resulting in a change of pitch; looping is an operation in which some part of the wave is played back repeatedly, in order to increase the duration of the wave.

The DLS oscillator, schematically depicted in FIG. 1, can be described as a module with two control signal inputs and one audio signal output. The first control input signal is the “gate” signal. This is a logical signal, which acts as an abstraction of a piano key state: when the key is pressed the gate signal is asserted and when the key is released the gate signal is reset. The event of the gate signal raising from 0 to 1 is commonly referred to as a “note on” event and the event of the signal dropping from 1 to 0 (e.g. when the player eventually releases the piano key) is commonly referred to as a “note off” event. This situation is depicted in FIG. 2. The second control input signal is the frequency signal. This signal designates the rate at which the oscillator should play its wave sample, usually in relation to some predefined pitch, commonly referred to as the “root pitch”. The oscillator output is an audio signal that corresponds to the aforementioned control signals, based on the wave sample and its properties.

When implementing the oscillator, there are several challenges involved in making the implementation efficient, which will be illustrated through the following example of a trivial implementation and of its drawbacks, with reference to FIG. 1. At a given point in time, the oscillator has a certain pitch shift rate, expressed as the ratio between the desired pitch and the original pitch of the wave. In addition, the wave samples are known in advance, as well as the positions of the start and end of the loop section. FIG. 1 shows the original wave with its sections, including the loop section proceeded by a transient section and followed by a release section.

It is desired, in this example, to play back the wave as transient-loop-loop-loop-loop-release, whereas the transition to the release section is signaled by the “note-off” event.

In a trivial implementation a cursor is kept, pointing at a certain position in the original wave. For every sample that has to be generated the cursor is advanced according to the current ratio. In general, the ratio is not an integer number, so said cursor position is generally found between two samples, rather than on one sample. In order to estimate the wave's value in this position, interpolation is needed. Interpolating involves calculating a function of several neighboring samples of the position of interest. In general, for achieving a high level of interpolation many neighboring samples have to be examined. The term “environment” shall be used herein to refer to the time range surrounding the cursor position, in which those neighboring samples reside.

U.S. Pat. No. 5,753,841 describes a PC audio circuit that interfaces with and provides audio enhancement to a host personal computer of the type including a central processor, system memory and a system bus. The PC audio circuit includes a digital signal processor (DSP) for processing wavetable data and generating digital audio signals for a plurality of voices. The wavetable data is stored in the host computer's system memory and transferred in portions, as needed by the DSP, to a smaller, low-cost cache memory included with the PC audio circuit. The DSP processes several frames of data samples for an active voice before processing another voice.

Prior art methods such as the one described above suffer from various drawbacks. Since a loop is involved, sometimes the samples involved in the interpolation are not consecutive in memory, i.e. some of them are at the end of the loop while others are at the start of the loop. This requires a constant mapping between the “virtual” position of the sample and the physical position in the original wave, which is very resource-consuming. In addition, it is necessary constantly to check for a note-off event, in order to decide when to jump to the release section. However, since the cursor might be located near the end of the loop at the time of the event, the interpolation may already have taken into account samples from the start of the loop, and the process is therefore forced to loop one more time, i.e., one time more than desired.

This logic becomes even more complicated when considering very short loops—sometimes even shorter then the size of the environment used for interpolation calculation. Calculating the actual interpolation function is also resource-consuming, if implemented trivially, because it generally involves the calculation of an index within a lookup table, containing values to be multiplied with the samples.

It is important to understand that every clock cycle is of importance, since the process involves a very small number of operations to be performed per sample, which are repeated millions of times in a second.

There is, therefore, a need in the art for a solution to the above-described problem, which allows to minimize the number of operations needed per sample. It is an object of the present invention to provide a method that overcomes the above-described disadvantages of prior art methods.

### SUMMARY OF THE INVENTION

The invention is concerned with a method for organizing a wave sample in a memory, comprising loading the wave in two parts, each of which is a continuous waveform, wherein a discontinuity is provided between said two parts. According to a preferred embodiment of the invention the first of the two parts contains N -1 leading zeros, followed by a Transient section, followed by the first N samples of the loop, wherein N is an integer.

According to another preferred embodiment of the invention, the Loop section is duplicated more than once to achieve the desired number of samples L. Preferably, the second of the two parts contains the last N samples of the Loop section, followed by a Release section. In a preferred embodiment of the invention leading zeros are added before the transient part and trailing zeros are added after the release section.

In a particular embodiment of the invention the wave is a “loop forward” type of wave and the second part of the wave is dispensed with. In a further particular embodiment of the invention the wave is a “one shot” type of wave and the Transient and Loop portions are dispensed with.

The invention also encompasses a memory in which a wave has been loaded, wherein said wave is loaded in two parts, each of which is a continuous waveform, wherein a discontinuity is provided between said two parts.

### BRIEF DESCRIPTION OF THE DRAWINGS

In the drawings:

FIG. 1 schematically depicts a DLS oscillator;

FIG. 2 schematically shows the “note on” and “note off” events;

FIG. 3 schematically illustrates the Looping operation in a looped wave sample of type “loop and release”;

FIG. 4 schematically illustrates the way in which the wave sample is arranged at the time of loading, according to a preferred embodiment of the invention;

FIG. 5 schematically illustrates the loading of a “one shot” kind of wave;

FIG. 6 schematically shows the implementation of the looping method according to a preferred embodiment of the invention; and

FIG. 7 is a state machine, which illustrates the behavior for each of the events in the looping process, according to a preferred embodiment of the invention.

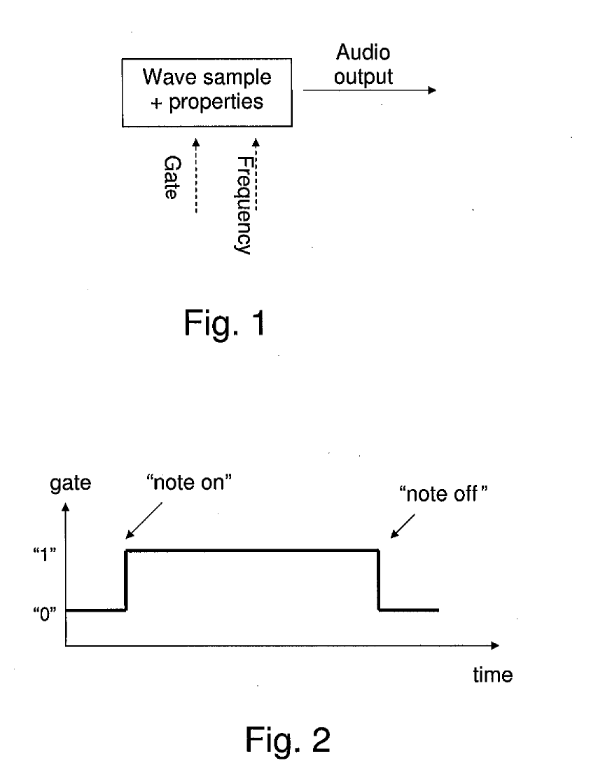

### DETAILED DESCRIPTION OF PREFERRED EMBODIMENTS

All the above and other characteristics and advantages of the invention will be better understood through the following illustrative and non-limitative description of preferred embodiments thereof.

In order to better understand the invention the following background explanation is provided. As explained above, the oscillator part of the audio engine is responsible for the pitch shifting and looping of a wave sample. This is done by ‘walking’ the wave sample, jumping in steps equal to the pitch shift ratio. The value of the wave in a position that lies between two samples is evaluated by interpolation of some neighboring samples.

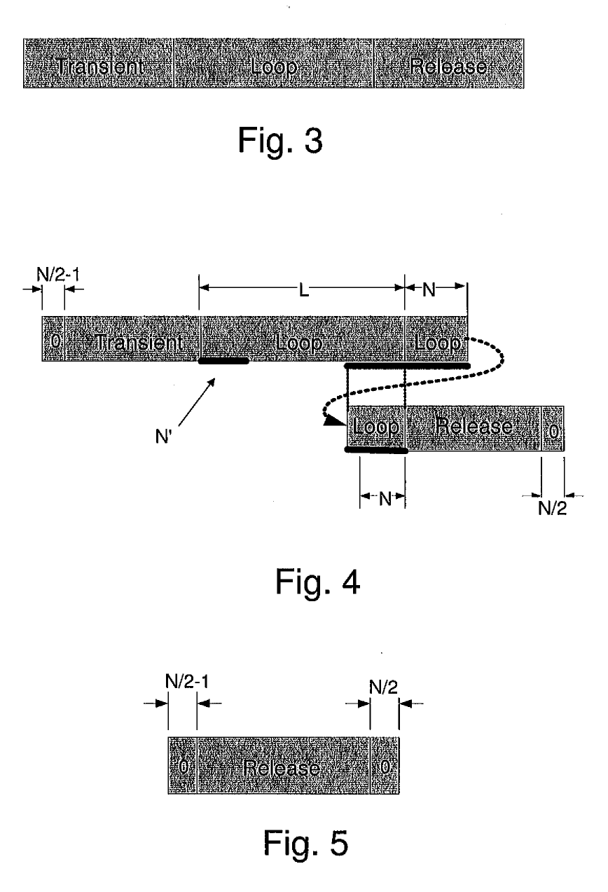

Looping, in the general case is done as follows: DLS defines a looped wave sample of type “loop and release” as shown in FIG. 3. While walking on wave sample, each time the end of loop is reached, a jump to start of loop is done as long as the note is not released (note off). As soon as the note off event arrives, we further wait until the cursor reaches the loop end point, and then proceed to playing the Release section. This behavior might incur expensive calculations and conditions to get indices of the interpolation samples, which severely harm performance if implemented trivially.

The other two cases of looping can be regarded and special cases of this case:
The “Loop forward” mode is like “loop and release”, while completely ignoring the note off event, resulting in never reaching the Release section.
The “One shot” mode is like having a 0-length Transient and Loop sections and triggering the note off right after starting the playback, resulting in immediate jump to the Release section.

The present invention optimizes the oscillator processing while handling looping in wave sample. Specifically, the invention allows to reduce the number of operations that have to be done on a per-sample basis.

In order to operate according to the invention it is needed to interpolate the value of the wave sample x(t)at some arbitrary real time t, where only its values at integer times x[n] are given. The method of the invention involves separating t into its integer and fractional parts as follows: t=tᵢ+t_{f}, where tᵢ is an integer and t_{f}ε[0,1). Interpolation is then done by applying an interpolation function on a certain set of samples contained in a fixed environment of t, i.e. \hat{x}(t)=f(x[n₁],x[n₂], . . . ,x[n_{N}]) such that n₁,n₂, . . . ,n_{N}ε(t+Tₘᵢₙ,t+Tₘₐₓ] are all the points contained in this environment. Without limiting the generality of the method, it is always possible to expand the environment (by reducing Tₘᵢₙ and increasing Tₘₐₓ). According to the invention said environment is expanded so that it will always be of an integer, even length, where t is right in the middle. Hence, from now on we will assume that the environment of the interpolation points is always of the form

$$( t - \frac{N}{2} , t + \frac{N}{2} ] ,$$

where N is an even integer. Therefore, the set of points needed will always be

$${t}_{i} - \frac{N}{2} + 1 , {t}_{i} - \frac{N}{2} + 2 , ... , {t}_{i} + \frac{N}{2}$$

a total of N points, determined only by tᵢ (which will save computations and hence we reduce demand on the engine resources later on).

When enabling anti-aliasing, the interpolator length is not constant. However, it can be bounded. According to the invention it is preferred to use the longest possible N for the above purposes (since using an N louder than needed does not present any critic of disadvantage, although it is slightly wasteful in memory).

Organization of Wave Sample in Memory

If the loop is long enough and the pitch shift ratio is reasonably small, most of the time all alterations would be carried out on continuous blocks of data (i.e. jumps will be quite rare). Additionally, as long as the ratio does not change, it is possible to calculate in advance the length of a continuous block, thus eliminating the need to check for loop point/end point at every sample, and avoiding “jumping” the cursor often.

It should also be understood that if the samples needed for interpolation are not continuous as a result of crossing loop point, the interpolation operations become much more cumbersome, and result in a poor utilization of memory caching.

In order to achieve sufficiently long loops, the loop part can be unrolled a few times, at the expense of memory space, and time resolution of the transition between the loop part and the release part i.e. whereas in the original (short) loop a transition to the release section is guaranteed to occur very quickly after the note off event, in the new (unrolled, longer) loop setting it might take a little bit longer. That is to say, unrolling the loop does not result in a perfectly equivalent model, but rather may be considered an equivalent model with the exception of the note off event being slightly delayed.

For the purpose of the explanation to follow it will be assumed that L is an arbitrary, “sufficiently large” number of samples, which sets the right trade-off between likelihood of “jumps” and memory consumption/time resolution. L, of course, must be no less than the original loop length, and an integer multiple of it, and also no less than N. From this point on in the explanation to follow it will be assumed that the loop is “sufficiently long”, disregarding the fact that it was might have been originally short and artificially prolonged.

In order to guarantee that all the samples required for interpolation of a single point will be continuous, some further duplication of data will also be needed, as will be described below.

According to a preferred embodiment of the invention the wave sample is arranged, at the time of loading the wave sample, as shown in FIG. 4. As can be seen in the figure, the wave is loaded in two parts, each of which is a continuous waveform, but there is a discontinuity between them:
Part 1 contains

$$\frac{N}{2} - 1$$

leading zeros, followed by the Transient section, followed by the Loop section, optionally duplicated more than once to achieve the length of L, followed by the first N samples of the loop. It should be noted that the first N samples of this part (indicated by N′) are identical to the last N samples.
Part 2 contains the last N samples of the Loop section, followed by the Release section, followed by

$$\frac{N}{2}$$

trailing zeros. It should be noted that the first N samples of this part are identical to the last N samples of the loop section of part 1 (emphasized on the diagram).

In a “loop forward” kind of wave, the 2^{nd} part is not needed.

In a “one shot” kind of wave, the wave is loaded as shown in FIG. 5.

Implementing Looping

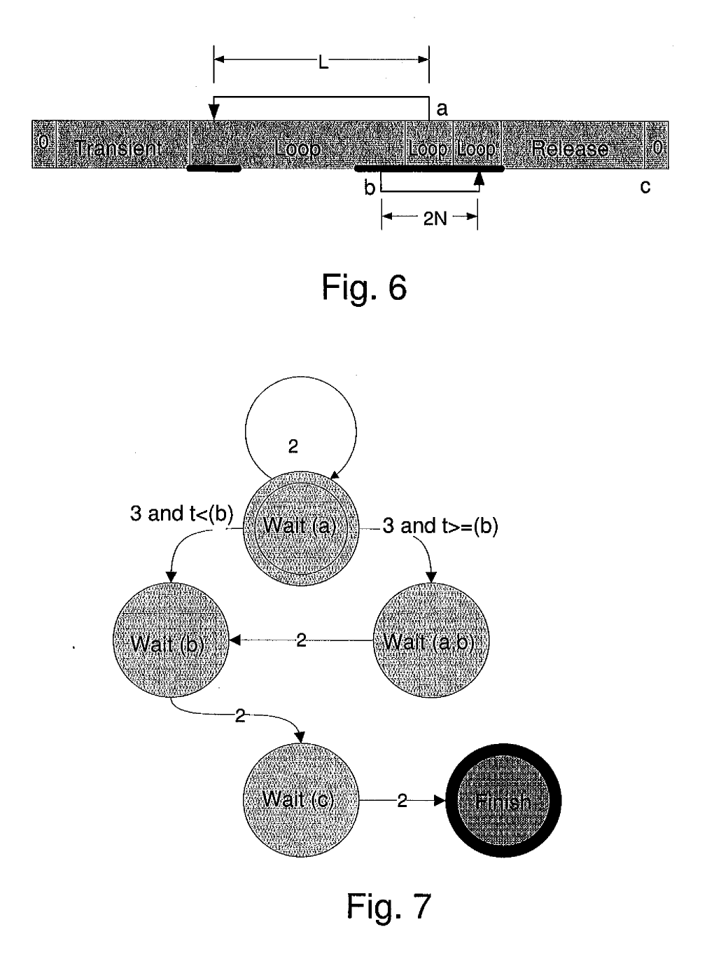

Since DLS loops are always of integer length, looping involves manipulating only the integer part of the cursor position. Having loaded the wave as described above, two kinds of “jumps” can be performed:
1. A jump of L samples backwards to achieve looping.
2. A jump of 2N samples forward to transition to the release section, as shown in FIG. 6.

It should be noted that both jumps are between identical environments of length N.

Besides these two jumps, all other cursor movement are performed continuously, so that jumps can be made more rare by increasing L.

According to a preferred embodiment of the invention, the process for controlling the cursor position comprises the following steps:
1) the process starts by placing it in position N/2, right after the leading zeros section.
2) At every step, it is advanced by a step of size s.
3) When it crosses point (a) (FIG. 6), it is taken back.
4) When note-off has been signaled (by drop of the gate signal), the process waits until point (b) is crossed and the cursor is then advanced by 2N.
5) The process continues until point (c) is reached.

A specific and rare case is that in which s>L the amount by which it is necessary to take the cursor back can be calculated in advance as

$${L}^{′} = ( 1 + ⌊ \frac{s}{L} ⌋ ) \cdot L .$$

However, this is a very inefficient situation which is best avoided by increasing the value of L.

In “loop forward” waves, Steps 5 and 4 other ignored.

In “one shot” waves, Steps 2, 3 and 4 are ignored.

It should be noted that most of the time the process operates on continuous blocks of data, that can only be terminated by points (a), (b) or (c). Since the positions of these points are known in advance, the number of steps that can be safely performed without having to check for any excess conditions can be calculated on every start of block by

$$B = \vert \frac{{t}_{d} - t}{s} \vert ,$$

where t_{d} is the time of the respective destination point that terminates the continuous block, t is the current cursor position, and s is the step size. Said block size will have to be recalculated whenever one of the following events occurred:
1. The step size has changed.
2. The destination point has been reached.
3. The destination point has been changed (as a result of a “note-off” signal).

Otherwise, the cursor can simply be advanced by s for at least B times.

The state machine, shown in FIG. 7, illustrates the behavior for each of the above-described events and is provided to facilitate the understanding of the process:
For “one shot” waves start directly from state “Wait (c)”.
For “loop forward” waves, ignore event 3 (always stay in state Wait (a)).
Each event triggers re-calculation of remaining block length:
   Upon transition into Wait (a) calculate according to point (a).
   Upon transition into Wait (a,b) calculate according to point (a).
   Upon transition into Wait (b), calculate according to point (b).
   Upon transition into Wait (c), calculate according to point (c).
Event 1 doesn't change state, but still triggers re-calculation of remaining block length.
When in state Wait (a), if receiving event 3, the current cursor position needs to be matched against point (b) in order to decide the next state.

Implementing Interpolation

The following interpolation methods are provided as an illustration to facilitate the understanding of the invention.

Linear Interpolation

Linear interpolation is a special case, where N=2. In this case, the points used are tᵢ,tᵢ+1, and the interpolated value is calculated simply as \hat{x}(t)=(1−t_{f})−x[tᵢ]+t_{f}·x[tᵢ+1].

Mask Based Interpolation (No Anti-Aliasing)

This interpolation method is more accurate and involves a multiply-and-accumulate step of the neighboring samples and a mask function, which is shifted along with the cursor:

$$\begin{matrix}\hat{x} ( t ) = {\sum }_{k = - \frac{N}{2} + 1}^{\frac{N}{2}} x [ {t}_{i} + k ] \cdot m ( t - ( {t}_{i} + k ) ) \\ = {\sum }_{k = - \frac{N}{2} + 1}^{\frac{N}{2}} x [ {t}_{i} + k ] \cdot m ( {t}_{f} - k )\end{matrix}$$

it should be noted that the argument of the masking function is only dependent in t_{f}, and that its range is

$$[ - \frac{N}{2} , \frac{N}{2} ) .$$

For simplicity of indexing (the masking function is stored in an array), the mask will be shifted by N/₂, so that it will be defined in the range [0, N), and thus the interpolation formula becomes:

$$\begin{matrix}\hat{x} ( t ) = {\sum }_{k = - \frac{N}{2} + 1}^{\frac{N}{2}} x [ {t}_{i} + k ] \cdot \tilde{m} ( {t}_{f} - k + \frac{N}{2} ) \\ = {( \begin{matrix}x [ {t}_{i} - \frac{N}{2} + 1 ] \\ x [ {t}_{i} - \frac{N}{2} + 2 ] \\ ⋮ \\ x [ {t}_{i} + \frac{N}{2} ]\end{matrix} )}^{T} ( \begin{matrix}\tilde{m} ( {t}_{f} + N - 1 ) \\ \tilde{m} ( {t}_{f} + N - 2 ) \\ ⋮ \\ \tilde{m} ( {t}_{f} )\end{matrix} )\end{matrix}$$

For efficiency of calculation it should be pointed out that:
The indices of x[n] are consecutive.
The indices of \tilde{m}(t) are exactly in Jumps of −1, starting at t_{f}.
   As will be appreciated by the skilled person, when operating according to the invention all that is needed is a loop of N repetitions and two pointers to the vectors, which are updated at every step. This can be implemented by initializing the argument of \tilde{m}(t) to t_{f}+N−1 and decreasing 1 at every repetition until the argument becomes negative.

Masked Based Interpolation (with Anti-Aliasing)

In this case, it is desired to stretch the mask by a factor of a>1 (usually it is the step size, unless a certain limit is reached. This limit is needed in order to prevent having to include a large number of samples in the interpolation, which will result in too many computations per sample).

$$\hat{x} ( t ) = {\sum }_{k = - \frac{{N}^{′}}{2} + 1}^{\frac{{N}^{′}}{2}} x [ {t}_{i} + k ] \cdot m ( \frac{{t}_{f} - k}{a} )$$

As a result of the stretching, the environment of samples examined in x[n] has grown, and it will be needed to expand it, such that its size will still be an even integer, for the reasons described above:

$${N}^{′} = 2 \cdot ⌈ \frac{a \cdot N}{2} ⌉ .$$

This will require extending the range of definition of m(t) to

$$\begin{matrix}[ - \frac{{N}^{′}}{2 a} , \frac{{N}^{′}}{2 a} ) = [ - \frac{⌈ \frac{aN}{2} ⌉}{a} , \frac{⌈ \frac{aN}{2} ⌉}{a} ) \underline{⋐} [ - \frac{\frac{aN}{2} + 1}{a} , \frac{\frac{aN}{2} + 1}{a} ) \\ = [ - \frac{N}{2} - \frac{1}{a} , \frac{N}{2} + \frac{1}{a} ) \underline{⋐} [ - \frac{N}{2} - 1 , \frac{N}{2} + 1 ) ,\end{matrix}$$

by padding it with zeros over a range of 1 from each side.

The sum will then take the form:

$$\begin{matrix}\hat{x} ( t ) = {\sum }_{k = - \frac{{N}^{′}}{2} + 1}^{\frac{{N}^{′}}{2}} x [ {t}_{i} + k ] \cdot m ( \frac{{t}_{f} - k}{a} ) \\ = {\sum }_{k = - \frac{{N}^{′}}{2} + 1}^{\frac{{N}^{′}}{2}} x [ {t}_{i} + k ] \cdot \tilde{m} ( \frac{{t}_{f} - k}{a} + \frac{N}{2} ) \\ = {( \begin{matrix}x [ {t}_{i} - \frac{{N}^{′}}{2} + 1 ] \\ x [ {t}_{i} - \frac{{N}^{′}}{2} + 2 ] \\ ⋮ \\ x [ {t}_{i} - \frac{{N}^{′}}{2} ]\end{matrix} )}^{T} ( \begin{matrix}\tilde{m} ( \frac{{t}_{f} + \frac{{N}^{′}}{2} - 1}{a} + \frac{N}{2} ) \\ \tilde{m} ( \frac{{t}_{f} + \frac{{N}^{′}}{2} - 2}{a} + \frac{N}{2} ) \\ ⋮ \\ \tilde{m} ( \frac{{t}_{f} - \frac{{N}^{′}}{2}}{a} + \frac{N}{2} )\end{matrix} )\end{matrix}$$

For efficient calculation it is noted that:
The indices of x[n] are consecutive.
The indices of m(t) are exactly in jumps of

$$- \frac{1}{a} ,$$

starting at

$$\frac{{t}_{f} + \frac{{N}^{′}}{2} - 1}{a} + \frac{N}{2} = \frac{{t}_{f}}{a} + \underbrace{\frac{{N}^{′} - 2}{2 a} + \frac{N}{2}}_{= d} = \frac{{t}_{f}}{a} + d .$$

Thus, the multiply and accumulate can be implemented like in the previous case. If the argument of \tilde{m}(t) is used as the terminal condition of the loop (stop when negative), it even saves the need to pad \tilde{m}(t) from the negative side.

In order to save computations of the start argument, it can be computed recursively as follows:
Assume that the argument at time

$${t}_{f} \text{:} c ( {t}_{f} ) = \frac{{t}_{f}}{a} + d$$

is known;
It is now desired to compute the argument at time

$${t}_{f}^{′} = ( {t}_{f} + s ) mod 1 = [ \begin{matrix}{t}_{f} + {s}_{f} ; & {t}_{f} < 1 - {s}_{f} \\ {t}_{f} + {s}_{f} - 1 ; & o / w\end{matrix} ]$$

Which is done by:

$$c ( {t}_{f}^{′} ) = \frac{{t}_{f}^{′}}{a} + d = [ \begin{matrix}c ( {t}_{f} ) + \frac{{s}_{f}}{a} ; & {t}_{f} < 1 - {s}_{f} \\ c ( {t}_{f} ) + \frac{{s}_{f}}{a} - \frac{1}{a} ; & o / w\end{matrix} ]$$

The quantities an

$$\frac{{s}_{f}}{a} , \frac{1}{a} ,$$

and 1−s_{f} can be calculated in advance, every time the step size changes.
Trying to implement this recursion naively using fixed-point arithmetic is risky: small inaccuracies in the computation of

$$\frac{1}{a}$$

and

$$\frac{{s}_{f}}{a}$$

may eventually result in a cumulative error in c(t_{f}), which will cause exceeding the valid range of \tilde{m}(t). Thus, it should be noted that:

$$\begin{matrix}{t}_{f} < 1 - {s}_{f} \\ ⇕ \\ c ( {t}_{f} ) = d + \frac{{t}_{f}}{a} < d + \frac{1 - {s}_{f}}{a} \\ ⇓ \\ c ( {t}_{f}^{′} ) = [ \begin{matrix}c ( {t}_{f} ) + \frac{{s}_{f}}{a} ; & c ( {t}_{f} ) < d + \frac{1 - {s}_{f}}{a} \\ c ( {t}_{f} ) + \frac{{s}_{f}}{a} - \frac{1}{a} ; & o / w\end{matrix} ] \\ ⇓ \\ d \leq c ( {t}_{f}^{′} ) < d + \frac{1}{a}\end{matrix}$$

Hence, we can use the following algorithm for obtaining c(t_{f}′) from c(t_{f}):

$$c ( {t}_{f}^{′} ) = c ( {t}_{f} ) + \frac{1}{a}$$

If the result exceeds

$$d + \frac{1}{a} ,$$

decrease

$$\frac{1}{a} .$$

The above description of preferred embodiments has been provided to illustrate the invention and is not intended to limit its scope in any way. Using the method described herein it is possible to efficiently process large blocks of samples, where most of the operations are done either during load-time, or once per block, and as little as possible operations are done per sample. Operating according to the invention increases CPU cycle consumption by a factor of 3-5, which results in a significant improvement of the overall performance of the synthesizer, and eventually enables reaching higher polyphony levels.

1. A method for organizing a wave sample in a memory, comprising loading the wave in two parts, each of which is a continuous waveform, wherein a discontinuity is provided between said two parts.

2. A method according to claim 1, wherein the first of the two parts contains
$$\frac{N}{2} - 1$$
leading zeroes, followed by a Transient section, followed by the first N samples of the loop, wherein N is an integer.

3. A method according to claim 2, wherein the Loop section is duplicated more than once to achieve the desired number of samples L.

4. A method according to claim 1, wherein the second of the two parts contains the last N samples of the Loop section, followed by a Release section.

5. A method according to claim 4, wherein leading zeros are added before the transient part and trailing zeros are added after the release section.

6. A method according to claim 1, in which the wave is a “loop forward” type of wave and in which the second part of the wave is dispensed with.

7. A method according to claim 1, in which the wave is a “one shot” type of wave and in which the Transient and Loop portions are dispensed with.

8. A memory in which a wave has been loaded, wherein said wave is loaded in two parts, each of which is a continuous waveform, wherein a discontinuity is provided between said two parts.

9. A memory according to claim 8, wherein the first of the two parts contains
$$\frac{N}{2} - 1$$
leading zeroes, followed by a Transient section, followed by the first N samples of the loop, wherein N is an integer.

10. A memory according to claim 9, wherein the Loop section is duplicated more than once to achieve the desired number of samples L.

11. A memory according to claim 8, wherein the second of the two parts contains the last N samples of the Loop section, followed by a Release section.

12. A memory according to claim 9, wherein the first N samples of the second part are identical to the last N samples of the loop section of the first part.

13. A memory according to claim 8, wherein the wave is a “loop forward” type of wave and in which the second part of the wave is dispensed with.

14. A memory according to claim 8, wherein the wave is a “one shot” type of wave and in which the Transient and Loop portions are dispensed with.

15. A memory according to claim 11, wherein the first N samples of the second part are identical to the last N samples of the loop section of the first part.
